(19) United States
(12) Patent Application Publication
(10) Pub. No.: US 2007/0174839 A1
(43) Pub. Date: Jul. 26, 2007

(54) Method and system for managing programs within systems

(76) Inventors: Ruriko Takahashi, Yokohama (JP); Takanobu Sasaki, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/373,098

(22) Filed: Mar. 13, 2006

(30) Foreign Application Priority Data
Jan. 24, 2006 (JP) 2006-014703

(51) Int. Cl. G06F 9/46

(52) U.S. Cl. 718/100

(57) ABSTRACT

A program management method for managing a number of task processing of execution when a computer for executing the task processing of a received request executes the task processing with a plurality of programs which extend across a plurality of processes, wherein a memory unit of the computer manages a resource usage volume for each task processing; and wherein a processing unit stops the task processing which has a largest resource usage volume when the resource usage volume exceeds a predetermined threshold.

### CROSS REFERENCE TO RELATED APPLICATIONS

This application claims the foreign priority benefit under Title 35, United States Code, §119(a)-(d) of Japanese Patent Applications No. 2006-014703, filed on Jan. 24, 2006, the contents of which are hereby incorporated by reference.

### BACKGROUND OF THE INVENTION

1. Field of the Invention

The present invention relates to a program management technology for executing programs in parallel within a computer.

2. Description of Relevant Art

A computer configuring an online system processes a demand (request), which is input through a terminal of the computer or another online computer, for executing a program installed in the computer. When the computer processes a plurality of requests, the computer may concurrently execute application programs (programs are also acceptable) by assigning them to a predetermined processing unit (for example, a process) for improving a computer performance in some case. In addition, a number of concurrent execution of the application programs is managed by the processing unit for efficiently implementing the processing. Technologies described above are disclosed, for example, in Japanese Laid-Open Patent Application Number H09-305414. If task processing corresponding to one request is executed with one process, the number of the concurrent execution can be managed by a task unit by using the technologies.

### SUMMARY OF THE INVENTION

However, in business processing, one application program is not always executed in one process. Therefore, when a plurality of processes, in which an application program is operated, exist, and also when the application program is executed in each process, it is impossible to manage a number of the concurrent execution of programs in the task processing.

Accordingly, considering the above issue, an object of the present invention is to provide a method for managing the number of the concurrent execution of programs in the task processing, when a plurality of the programs which extend across a plurality of processes are executed in parallel in the task processing within a computer. Here, the application program is a program which is booted (run) in some process.

According to the present invention which solves the aforementioned issue, there is provided a program management method for managing a number of task processing of execution when a computer for executing the task processing of a received request executes the task processing with a plurality of programs which extend across a plurality of processes, wherein a memory unit of the computer manages a resource usage volume for each task processing; and wherein a processing unit stops the task processing which has a largest resource usage volume when the resource usage volume exceeds a predetermined threshold. Meanwhile, in addition to the above, the present invention comprises another program management method, a computer and a program managing program as claimed in the climes.

According to the present invention, when a plurality of programs which extend across a plurality of processes are executed in parallel in task processing within computer, a number of the concurrent execution of the task processing can be managed.

### BRIEF DESCRIPTION OF THE DRAWINGS

FIG. 1 is an illustration showing a configuration of a computer according to an embodiment of the present invention;

FIG. 2 is an illustration showing a configuration of a task execution status managing table;

FIG. 3 is an illustration showing a configuration of a task execution priority defining table;

FIG. 4 is an illustration showing a configuration of a request trace;

FIG. 5 is an illustration showing a configuration of an application trace;

FIG. 6 is an illustration showing a configuration of a concurrent execution number adjustment rate defining table;

FIG. 7 is an illustration showing a configuration of a request stopping method defining table;

FIG. 8 is an illustration showing a configuration of a resource usage status table;

FIG. 9 is an illustration showing a configuration of a resource threshold defining table;

FIG. 10 is an illustration showing initialization processing of a computer;

FIG. 11 is a flowchart showing request reception processing of a computer;

FIG. 12 is a sequence chart showing an operation of request processing in detail;

FIG. 13 is a flowchart showing processing for determining a task of a stop target;

FIG. 14 is a flowchart showing processing for determining a request of a stop target;

FIG. 15 is a flowchart showing stopping processing of an application;

FIG. 16 is an illustration showing a transition of a trace document;

FIG. 17 is an illustration showing a transition of a trace document;

FIG. 18 is an illustration showing task processing at a predetermined time;

FIG. 19 is an illustration showing set contents of a task execution status managing table at a predetermined time;

FIG. 20 is an illustration showing set contents of a task execution priority defining table set in advance;

FIG. 21 is an illustration showing set contents of a concurrent execution number adjustment rate defining table set in advance;

FIG. 22 is an illustration showing set contents of a request stopping method defining table;

FIG. 23 is an illustration showing set contents of a request trace at a predetermined time;

FIG. 24 is an illustration showing set contents of an application trace at a predetermined time;

FIG. 25 is an illustration showing set contents of a resource usage status table at a predetermined time;

FIG. 26 is an illustration showing set contents of a task execution status managing table after request stopping; and

FIG. 27 is an illustration showing set contents of a request trace after request stopping.

### DESCRIPTION OF THE PREFERRED EMBODIMENTS

Hereinafter, a preferred embodiment of the present invention will be explained in detail by referring to figures.

<<Configuration and Outline of Computer>>

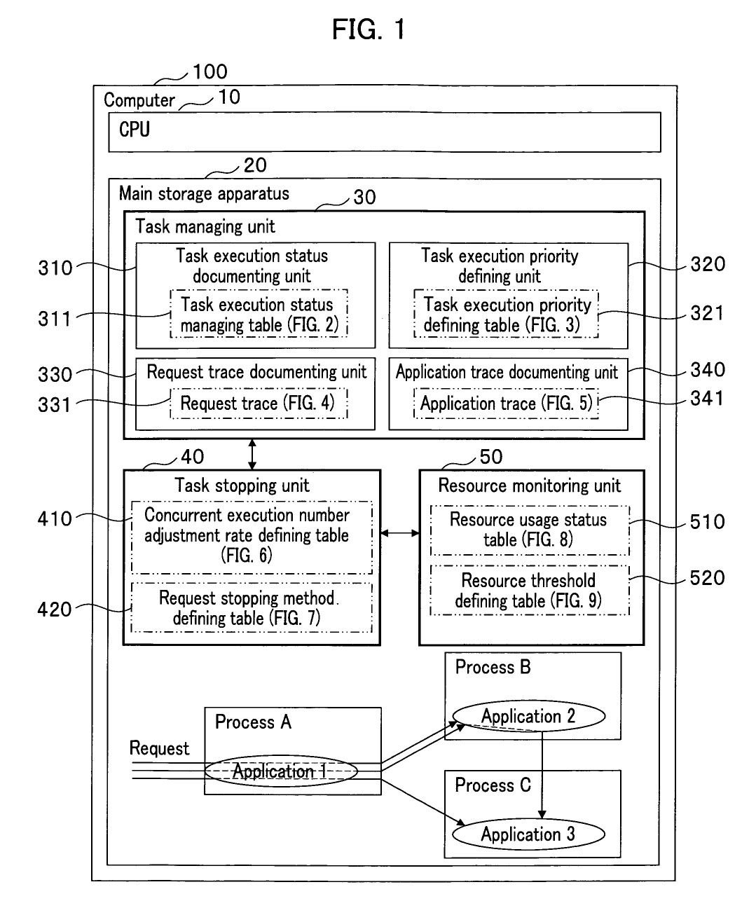

FIG. 1 is an illustration showing a configuration of a computer according to an embodiment of the present invention. A computer 100 is configured including a CPU (Central Processing Unit, processing unit) 10 and a main storage apparatus (memory unit) 20. The CPU 10 is a central processing unit for executing programs loaded on the main storage apparatus 20. The main storage apparatus 20 is a memory for storing program to be executed, and data to be referenced and updated, by the CPU 10.

In the main storage apparatus 20, a task managing unit 30, a task stopping unit 40, and a resource monitoring unit 50 are loaded, while a process for executing task processing is generated in the storage in response to a reception of the request (demand) to the program (hereinafter, referred to as application).

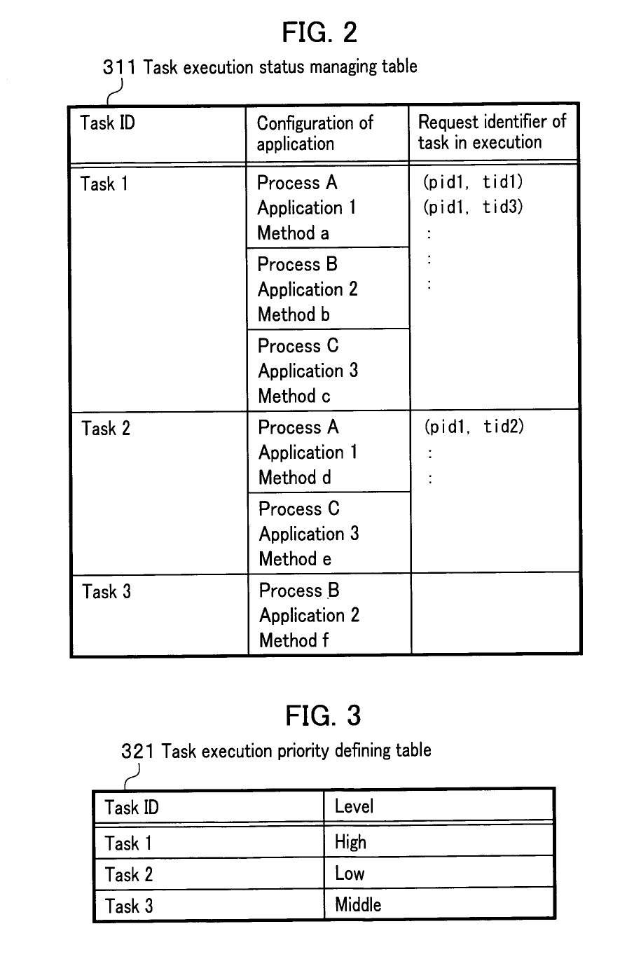

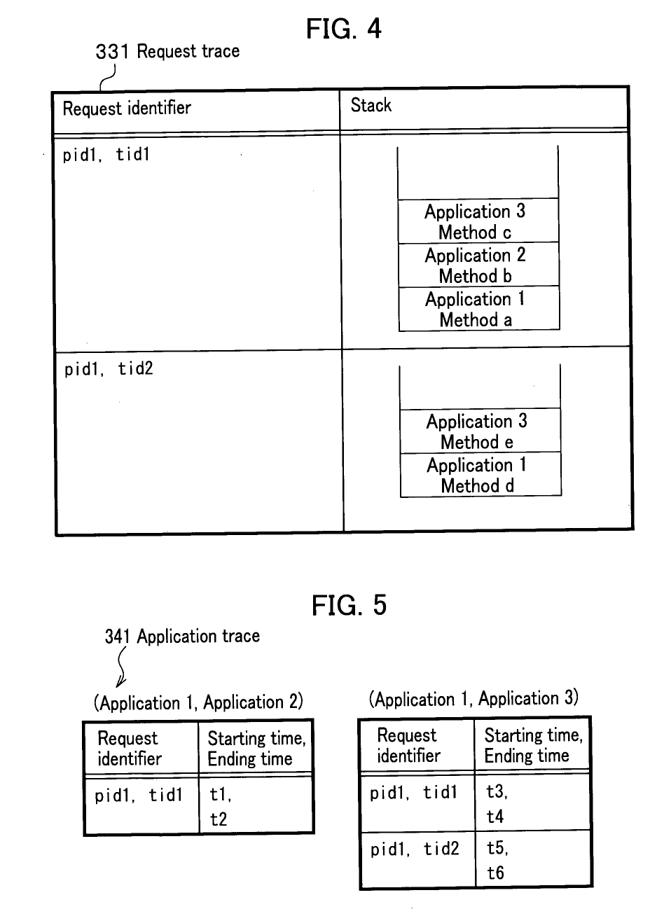

The task managing unit 30 has a function for managing execution of business processing, and includes a task execution status documenting unit 310, a task execution priority defining unit 320, a request trace documenting unit 330, and an application trace documenting unit 340. The task execution status documenting unit 310 documents a task execution status managing table 311 for managing a configuration of applications for each task and an execution status of each application. The details will be described later (refer to FIG. 2). The task execution priority defining unit 320 has a task execution priority defining table 321 for defining a priority for executing task processing. The details will be described later (refer to FIG. 3). The request trace documenting unit 330 documents a request trace (processing trace) 331 which stacks a method of application of task processing for the request. The details will be described later (refer to FIG. 4). The application trace documenting unit 340 documents an application trace 341, such as a starting time or an ending time of the processing for the request. The details will be described later (refer to FIG. 5).

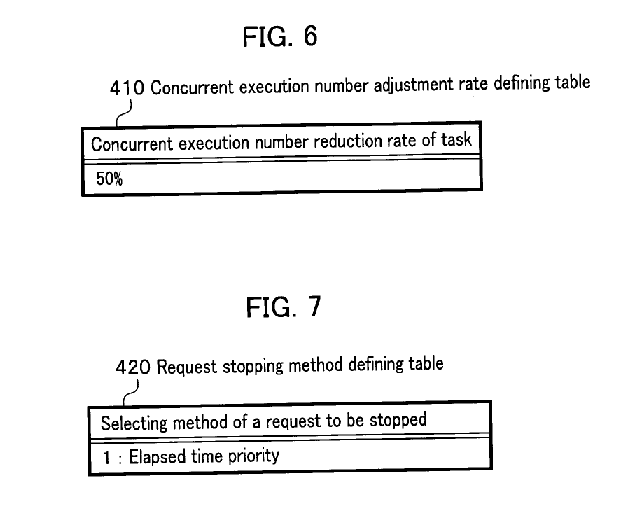

The task stopping unit 40 has a function for stopping execution of task processing, and includes a concurrent execution number adjustment rate defining table 410 and a request stopping method defining table 420. The concurrent execution number adjustment rate defining table 410 defines a rate for adjusting a concurrent execution number when task processing is stopped. The details will be described later (refer to FIG. 6). The request stopping method defining table 420 defines a stopping method for stopping task processing when the task processing is stopped. The details will be described later (refer to FIG. 7).

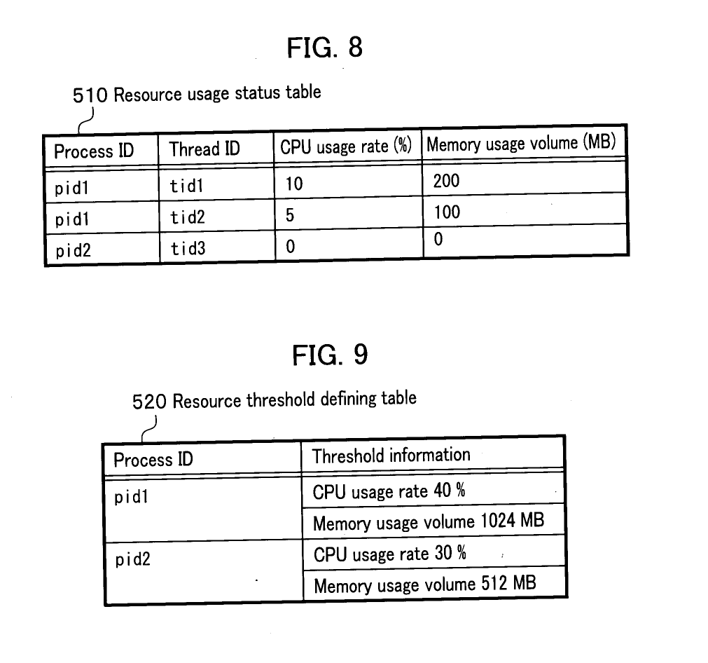

The resource monitoring unit 50 has a function for monitoring a status of a resource, such as a memory in executing task processing, and includes a resource usage status table 510 and a resource threshold defining table 520. The resource usage status table 510 indicates a status of usage of the CPU and the memory (resource usage volume). The details will be described later (refer to FIG. 8). The resource threshold defining table 520 defines a threshold as criteria for stopping the task processing. The details will be described later (refer to FIG. 9).

A process is generated in advance in the computer, and when a request for an application is received from outside (from input terminal or another online computer), processing corresponding to the request is executed in the process. In the process, the processing is executed by starting a thread. A plurality of processing corresponding to a plurality of requests are concurrently executed on the process. A number of the requests which are concurrently executed is a number of concurrent execution. In other words, a number of the plurality of task processing corresponding to the plurality of requests is the number of the concurrent execution.

An execution unit means a single thread in a process for executing a method of each application in a task. When same method of same application is executed in response to a reception of a plurality of requests, the execution unit (thread) is different by each request.

Meanwhile, processing of one application is not always executed for one request. As shown in FIG. 1, when an application 1 is executed for a predetermined request, an application 2 or an application 3 may be called (calling) from the application. 1 in some case. In addition, the application 3 may be further called from the application 2 which has been called from the application 1 in other case. Meanwhile, here, it is assumed that a process A executes processing of the application 1, a process B executes that of the application 2, and a process C executes that of the application 3. That is, the task processing for one request is executed in a plurality of applications extending across a plurality of processes. In this case, the calling among applications is implemented through a communication among processes.

An operation outline of the computer 100 is as follows. When the resource usage volume has exceeded the threshold during executing task processing, the resource monitoring unit 50 informs it to the task stopping unit 40. Next, the task stopping unit 40 determines a task and processing which should be stopped based on a predetermined procedure by referring to the task managing unit 30 and tables and traces of the resource monitoring unit 50, in response to a reception of information. Then, the thread (execution unit) related to determined processing is stopped by turns.

<<Configuration of Table>>

FIG. 2 is an illustration showing a configuration of a task execution status managing table. The task execution status managing table 311 is a table for managing a configuration of applications and an execution status of the applications for each task, and configured with a record which includes a task ID, the configuration of the applications, and a request identifier of a task which is in execution as items. The task ID is a specific number to a task corresponding to a request. The configuration of the applications indicates a process, an application and a method which will be practically executed for implementing task processing corresponding to the task ID, and is registered in advance for each task ID. The configuration of the applications for each task ID may be one application in some cases, and may be a plurality of applications in other cases. A unit for executing the method is a thread.

The request identifier of a task being in execution is an identifier indicating the thread which first executes task processing corresponding to the request, to be specific, it comprises a process ID specific to the process and a thread ID specific to the thread. This is data (request ID) specific to task processing. Referring to FIG. 2, they are written, for example, as such (p(process)id1, t(thread)id1). The request identifier of a task being in execution is stored in order of the chronologically oldest request identifier. Meanwhile, it can be seen from FIG. 2 that the task 1 and the task 2 are in execution of a plurality of processing, however, the task 3 is not in execution of processing since there is no thread being in execution.

FIG. 3 is an illustration showing a configuration of a task execution priority defining table. The task execution priority defining table 321 is a table for defining a priority of a plurality of task processing when the task processing corresponding to a request is executed, and configured with a record which includes the task ID and a level of the priority. The task ID is a number specific to a task corresponding to a request. The level indicates a degree of the priority of the task processing. Here, the priorities of high, low, and middle are assigned to the task 1, the task 2, and the task 3, respectively. Then, an order of the priority of the task processing is in order of the task 1, the task 3, and the task 2. The task execution priority defining table 321 is criteria for selecting task processing which has a low priority when task processing to be stopped is determined, and it is registered in advance.

FIG. 4 is an illustration showing a configuration of a request trace. The request trace 331 stacks methods of applications of task processing for a request, and configured with a record which includes the request identifier and a stack as items. The request identifier is an identifier indicating a first thread being in execution of task processing corresponding to the request, and comprises the process ID and the thread ID. Then, the request identifier becomes data (request ID) specific to the task processing corresponding to the request. The stack indicates a nest (depth of calling relation) of the methods of the applications which are in execution of task processing corresponding to the request identifier. As shown in FIG. 4, for example, the stack of the request identifier “pid1, tid1” is stacked in order of “application 1, method a”, “application 2, method b”, and “application 3, method c” from the bottom. This corresponds to the configuration of the applications of the task 1 shown in FIG. 2. In addition, although not shown in FIG. 4, a process ID of the process and a thread ID of the thread for executing the processing are documented, corresponding to a method of applications.

FIG. 5 is an illustration showing a configuration of an application trace. The application trace 341 is configured with a record which includes the request identifier, a starting time, and an ending time. The request identifier is an identifier indicating a first thread being in execution of task processing corresponding to a request, and comprises the process ID and the thread ID. The starting time and the ending time are a starting time and an ending time of processing of the thread, respectively. Therefore, when the ending time does not exist although the starting time of the application trace 341 exists, this indicates that task processing corresponding to the request identifier is being in execution. In addition, (application 1, application 2) indicates that the thread is an execution unit of the application 2 which is called from the application 1.

FIG. 6 is an illustration showing a configuration of a concurrent execution number adjustment rate defining table. The concurrent execution number adjustment rate defining table 410 is a table for defining a rate for adjusting a number of requests which will be concurrently executed if task processing is stopped, and configured with a record which includes a concurrent execution number reduction rate of tasks as an item. The concurrent execution number reduction rate of tasks indicates how many requests are stopped when task processing which should be stopped is determined. For example, in FIG. 6, the concurrent execution number reduction rate of tasks is 50%, indicating that 50% of the number of requests which are in concurrent execution is to be reduced. The concurrent execution number adjustment rate defining table 410 is registered in advance.

FIG. 7 is an illustration showing a configuration of a request stopping method defining table. The request stopping method defining table 420 is configured with a record which comprises a selecting method of a request to be stopped as an item. The selecting method of the request to be stopped indicates criteria for selecting task processing to be stopped. The criteria are, for example, “2: reception order priority” and “3: stack depth priority”, as well as “1: elapsed time priority” shown in FIG. 7.

The “elapsed time priority” selects task processing which has a long elapsed time after starting the processing. This is because the processing which has the long elapsed time has a possibility of hung-up due to a trouble, thereby resulting in preferentially stopping of the processing. Next, the “reception order priority” selects task processing of which reception order of the request is latest. This is because the task processing of which reception order is latest has a short elapsed time after starting the processing, thereby resulting in small effect on re-processing due to stopping of the processing, thereby resulting in preferentially stopping of the processing. The “stack depth priority” selects task processing of which stack is deep. This is because the task processing of which stack is deep is likely to consume many resources, such as a memory, proportional to a depth of the stack, thereby resulting in preferentially stopping of the task processing. Regarding the request stopping method defining table 420, a selection method of a request which should be stopped can be selected by a user, and a selected result is registered in advance. According to this method, the user can determine a suitable “selection method of a request to be stopped” by considering a characteristic of the task processing.

FIG. 8 is an illustration showing a configuration of a resource usage status table. The resource usage status table 510 is a table indicating a usage status of the CPU and the memory by each thread, and configured with a record which comprises the process ID, the thread ID, a CPU usage rate, and a memory usage volume. The process ID is a number specific to a process. The thread ID is a number specific to a thread within the process. The CPU usage rate (unit: %) indicates a usage percentage of the CPU in which the thread is processed. The memory usage volume (unit: MByte) indicates a usage volume of the memory when the thread is processed.

FIG. 9 is an illustration showing a configuration of a resource threshold defining table. The resource threshold defining table 520 is configured with a record which comprises the process ID and threshold information as items. The process ID is a number specific to the process. The threshold information indicates criteria for determining whether or not the task processing should be stopped, and the CPU usage rate and the memory usage volume are set in the threshold information as the thresholds. According to FIG. 9, it can be seen that, for example, task processing of the process ID “pid1” should be stopped when the CPU usage rate exceeds 40%, or when the memory usage volume exceeds 1024 MB. Meanwhile, the task processing may be stopped when the CPU usage rate or the memory usage volume exceeds the threshold, and also may be stopped when the CPU usage rate or the memory usage volume is equal to or exceeds the threshold. The resource threshold defining table 520 is registered in advance.

<Processing of Computer>

Next, processing of the computer 100, which has the aforementioned functional configurations and tables, for managing a number of requests concurrently being in execution by a task unit will be explained. First, initialization processing of the computer 100 will be explained. Next, processing of when the computer 100 receives a request from outside will be explained, and a procedure for stopping task processing will be summarized briefly. Then, the procedure, that is, processing for determining a task of a stop target, processing for determining a request of the stop target, and stopping processing of the request, will be explained in details, respectively. In addition, practical examples of a trace document and processing of request stopping will be explained.

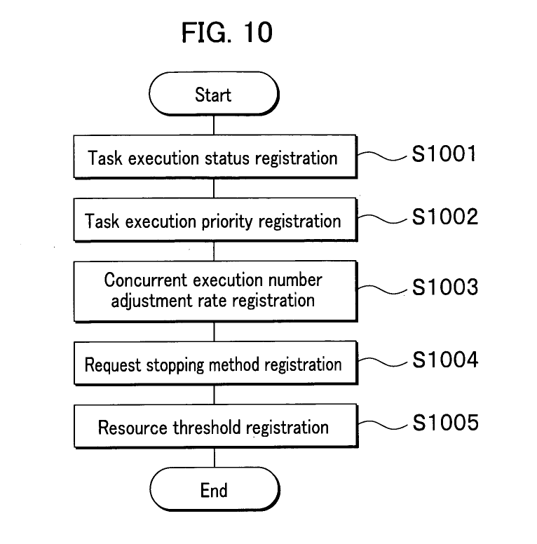

FIG. 10 is a flowchart showing initialization processing. The initialization processing is processing where the computer 100 registers preset values of each table in advance, that is, the processing where the preset values are set as default values when a power of the computer 100 is switched on, or the preset values are set by a selection of a user. First, the task managing unit 30 registers a task execution status in the task execution status managing table 311 (S1001). Here, the task execution status is a configuration of applications in task processing corresponding to the task ID (refer to FIG. 2). Next, the task managing unit 30 registers a task execution priority in the task execution priority defining table 321 (S1002). Here, the task execution priority is a level of task processing corresponding to the task ID (refer to FIG. 3). Next, the task stopping unit 40 registers a concurrent execution number adjustment rate in the concurrent execution number adjustment rate defining table 410 (S1003). Here, the concurrent execution number adjustment rate is a concurrent execution number reduction rate of the task (refer to FIG. 6). Subsequently, the task stopping unit 40 registers a request stopping method in the request stopping method defining table 420 (S1004). Here, the request stopping method is a selection method of a request which should be stopped (refer to FIG. 7). Further, the resource monitoring unit 50 registers a resource threshold in the resource threshold defining table 520 (S1005) Here, the resource threshold is the CPU usage rate and the memory usage volume of a process corresponding to the process ID (refer to FIG. 9).

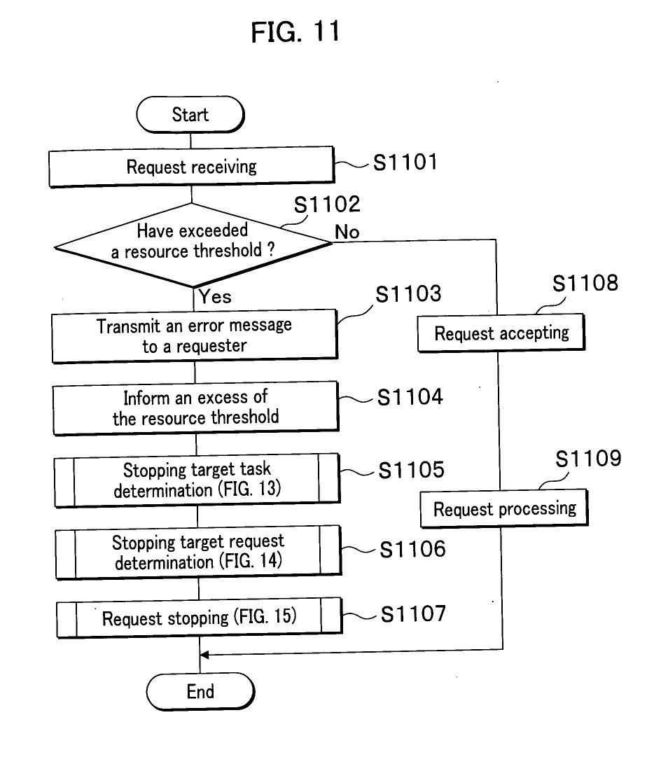

FIG. 11 is a flowchart showing request receiving processing. The processing is processing that the computer 100 executes when it receives a request from the input terminal thereof or from other computers. First, the computer 100 receives a request corresponding to an application (S1101). Next, upon receiving the request, the resource monitoring unit 50 evaluates whether or not task processing already being in execution has exceeded the resource threshold (S1102). To, be specific, the resource monitoring unit 50 sums up the CPU usage rate and the memory usage volume of the thread by each process ID by referring to the resource usage status table 510, and checks whether or not each sum of the CPU usage rate and the memory usage volume has exceeded the threshold information of the resource threshold defining table 520.

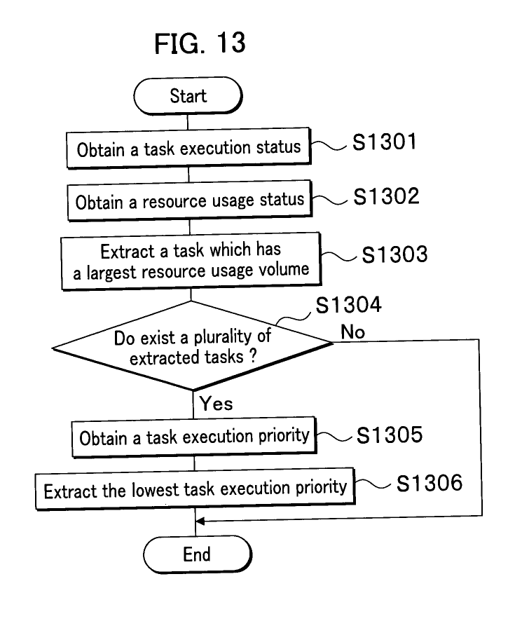

When the sum has exceeded the threshold (S1102: Yes), the computer 100 does not execute processing of a received request, and transmits an error message to a requester (S1103). Next, the resource monitoring unit 50 informs an excess of the resource threshold to the task stopping unit 40 (S1104). Then, the task stopping unit 40 first determines task processing of the stop target (S1105), and subsequently, determines a request of the stop target (S1106). After stopping the request (S1107), the request receiving processing is ended. Meanwhile, processing of S1105, S1106, and S1107 will be described in detail later (refer to FIGS. 13, 14 and 15).

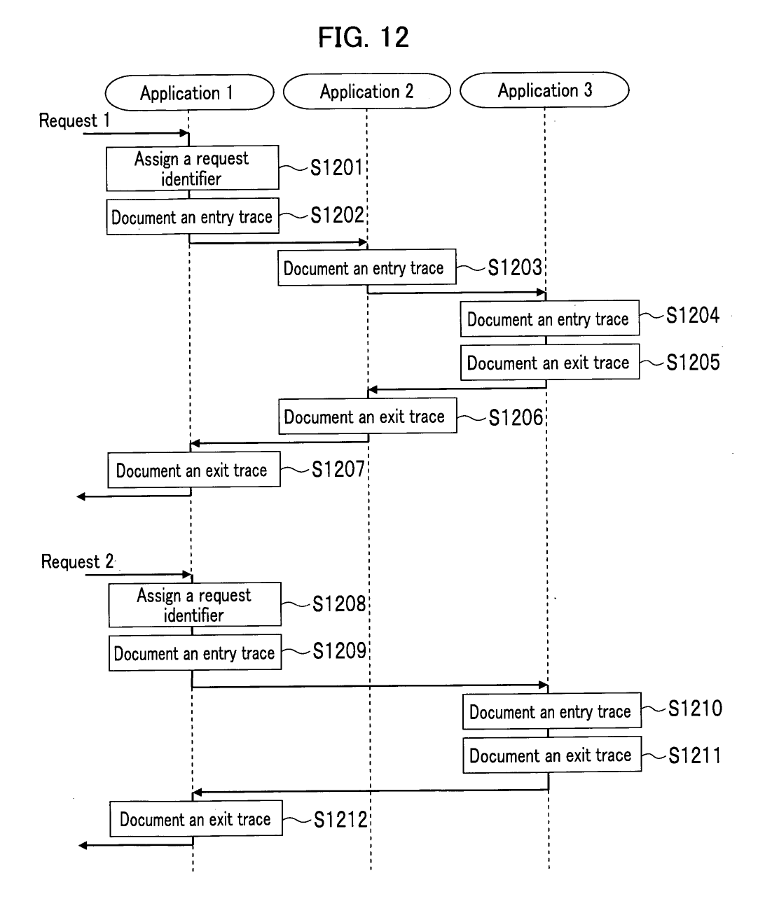

When the sum has not exceeded the threshold (S1102: No), the computer 100 executes (S1109) task processing (request processing) corresponding to the request by accepting (S1108) the received request. The details will be described later (refer to FIG. 12). After executing the task processing, the request receiving processing is ended.

Here, when the sum has exceeded the threshold (S1102: Yes), waiting of the processing once also may be available by putting the received request in a cue without transmitting the error message. Here, after stopping the request (S1107), the computer 100 re-evaluates (S1102) whether or not the sum has exceeded the resource threshold without ending the request receiving processing. With the above process, by checking the resource threshold and by stopping the request, when the sum becomes a status of not exceeding the resource threshold, the computer 100 can execute task processing corresponding to the request which is put in the que. Meanwhile, the error message implying a timeout of the processing may be transmitted to the requester when a predetermined time has elapsed during the resource threshold checking and request stopping.

FIG. 12 is an illustration of a sequence showing a detailed operation of request processing. In the illustration, task processing in detail is not explained, but an operation requested for managing processing which extends across applications will be mainly explained. First, if the application 1 receives a request 1, the application 1 assigns a request identifier (S1201). Practically, a process of the application 1 executes task processing with a thread by accepting the request 1. In the above, a process ID specific to the process and a thread ID specific to the thread which is first executed, are assigned to the request identifier. Next, an entry trace is documented (S1202). Practically, the request identifier is registered in the task execution status managing table 311 (refer to FIG. 2). Further, an application name and method name of the application 1 are documented in the stack (refer to FIG. 4) corresponding to the request identifier of the request trace 331, and a current time is documented in the starting time corresponding to the request identifier of the application trace 341 (hereinafter, same as above). Then, the application 1 calls the application 2.

The application 2 documents the entry trace immediately after the calling (S1203), and calls the application 3. The application 3 documents the entry trace immediately after the calling (S1204), then, documents an exit trace (S1205) immediately before returning to the caller. Practically, the application name and method name of the application 3 are deleted from the stack (refer to FIG. 4) corresponding to the request identifier of the request trace 331, and documents a current time in the ending time corresponding to the request identifier of the application trace 341 (hereinafter, same as above), then, the application 3 returns to the application 2.

The application 2 documents the exit trace (S1206) immediately before returning to the caller, and returns to the application 1. The application 1 documents the exit trace (S2107) immediately before ending the processing. Meanwhile, when the exit trace is documented, the request identifier of the task execution status managing table 311 (refer to FIG. 2) is deleted, and ends the processing after transmitting some reply to the requester.

On the other hand, when the application 1 receives a request 2, the application 1 assigns a request identifier (S1208), registers the request identifier to the task execution status managing table 311 (refer to FIG. 2), and documents the entry trace (S1209), then, calls the application 3. The application 3 documents the entry trace immediately after calling (S1210), then, documents the exit trace immediately before returning to the caller (S1211), and returns to the application 1. The application 1 documents the exit trace (S1212) immediately before ending the processing. In this case, the request identifier of the task execution status managing table 311 is deleted, and ends the processing after transmitting some reply to the requester.

FIG. 13 is a flowchart showing processing for determining a task of the stop target. The task stopping unit 40 of the computer 100 obtains (S1301) a task execution status from the task execution status managing table 311 of the task managing unit 30, and also obtains (S1302) a resource usage status from the resource usage status table 510 of the resource monitoring unit 50. Then, the task stopping unit 40 extracts (S1303) a task of which resource usage is largest among the tasks from the task execution status and the resource usage status, which are obtained in the above. Practically, first, a request identifier of a task being in execution is obtained by each task ID from the task execution status managing table 311. Next, the process ID and the thread ID (included in the stack) being in execution of task processing of the request identifier are obtained by referring to the request trace 331. Subsequently, the CPU usage rate and the memory usage volume of the process ID and thread ID being in execution are tallied up by each request identifier, and further, summed up by each task ID by using tallied data. Then, a task ID which has a largest summed up value of the CPU usage rate or the memory usage volume is extracted.

The task stopping unit 40 evaluates whether or not a plurality of tasks are extracted (S1304). This is evaluated from whether or not a plurality of task IDs which have a maximum summed up value of the CPU usage rate or the memory usage volume exist. If the plurality of tasks ID exist (S1304: Yes), levels (task execution priority) of the plurality of task IDs are obtained from the task execution priority defining table 321 (S1305). Then, a lowest level (task execution priority) within the obtained levels is extracted (S1306). A task which has the lowest level becomes the task of the stop target. If only one task is extracted at S1304 (S1304: No), the task becomes the stop target.

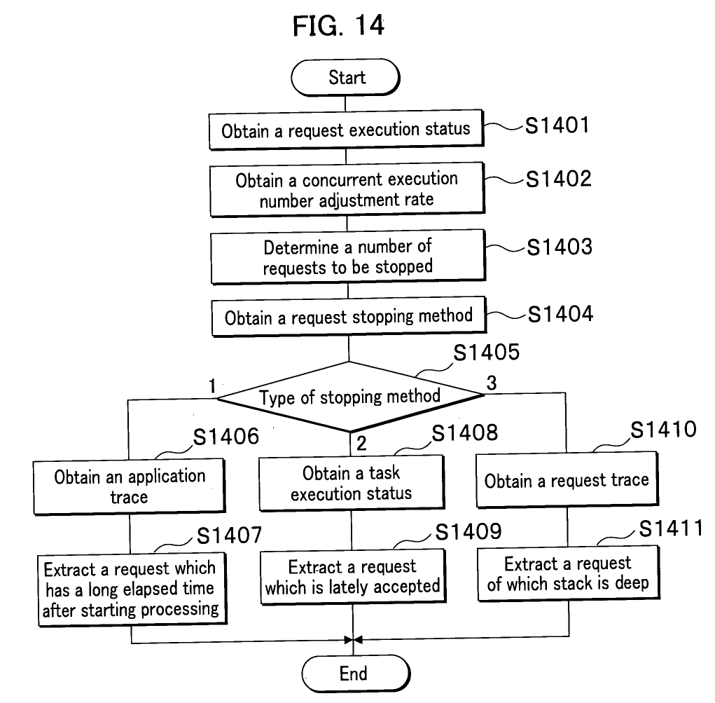

FIG. 14 is a flowchart showing processing for determining a request of a stop target. The task stopping unit 40 of the computer 100 first obtains a request execution status from the task execution status managing table 311 of the task managing unit 30 (S1401). Practically, the task stopping unit 40 gets a number of request identifier of a task being in execution of the task ID of the stop target from the task execution status managing table 311. This means to get a number of the request currently being in execution of the task. Next, a concurrent execution number reduction rate (concurrent execution number adjustment rate) of the task is obtained from the concurrent execution number adjustment rate defining table 410 (S1402). Then, the number of the request which should be stopped is determined by integrating the obtained number of the request being in execution and the concurrent execution number reduction rate of the task (S1403).

Subsequently, the task stopping unit 40 obtains a selecting method (request stopping method) of a request to be stopped from the request stopping method defining table 420 (S1404). When a type of the request stopping method is 1 (elapsed time priority) (S1405: 1), the task stopping unit 40 obtains the application trace 341 from the task managing unit 30 (S1406). Then, a request identifier which has a long elapsed time from the starting time to the current time out of the request identifier of which starting time is set, but ending time is not set, is extracted as many as the numbers of the stopping request (S1407).

When the type of the request stopping method is 2 (reception order priority) (S1405: 2), the task stopping unit 40 obtains the task execution status managing table 311 (task execution status) of the task managing unit 30 (S1408), and extracts a request identifier of a task being in execution from the bottom, that is, extracts a later request regarding the order of reception as many as the numbers of the stopping request (S1409).

When the type of the request stopping method is 3 (stack depth priority) (S1405: 3), the task stopping unit 40 obtains the request trace 331 of the task managing unit 30 (S1410), and extracts a request where many application methods are stacked, that is, a deeply stacked request as many numbers as that of the stopping request (S1411). Meanwhile, the task stopping unit 40 ends processing when the request which should be stopped is extracted.

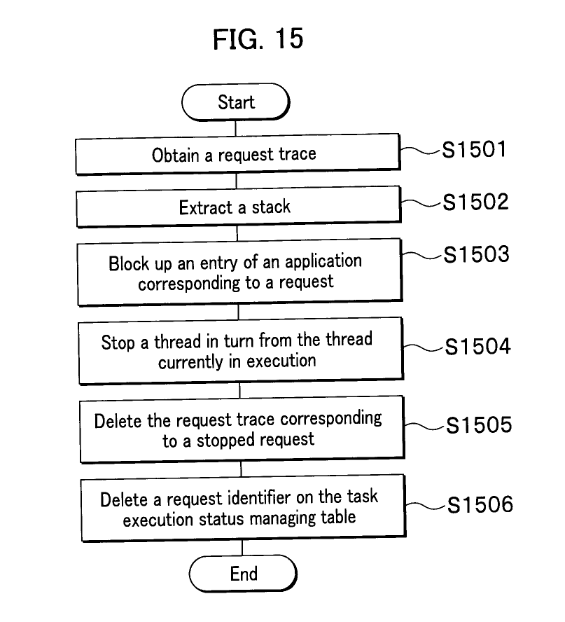

FIG. 15 is a flowchart showing stopping processing of an application. The task stopping unit 40 of the computer 100 first obtains the request trace 331 from the task managing unit 30 (S1501), next, extracts a stack from the request trace 331 (S1502). Then, based on information of the stack, the task stopping unit 40 blocks up (S1503) an entry of the application which accepts the request extracted through request determining processing of the stop target shown in the flowchart in FIG. 14. Practically, when the above request is received, the task stopping unit 40 commands to a server program not to receive the request and transmits an error message to the requester. Subsequently, the task stopping unit 40 stops a thread from the thread being in execution (S1504). Practically, an execution of the application method is stopped from the top of the stack. Further, the request trace 331 corresponding to the stopped request is deleted (S1505). This is not to delete stored trace information, but to delete the trace (instant value) of the request thereof which is stopped execution. Therefore, the stopped request is presumed that it has not been processed. In addition, the task stopping unit 40 deletes the request identifier of the task being in execution on the task execution status managing table 311 (S1506). This is to delete the request identifier corresponding to the stopped request since the stopped request becomes to be not in execution.

<Specific Example of Trace Document>

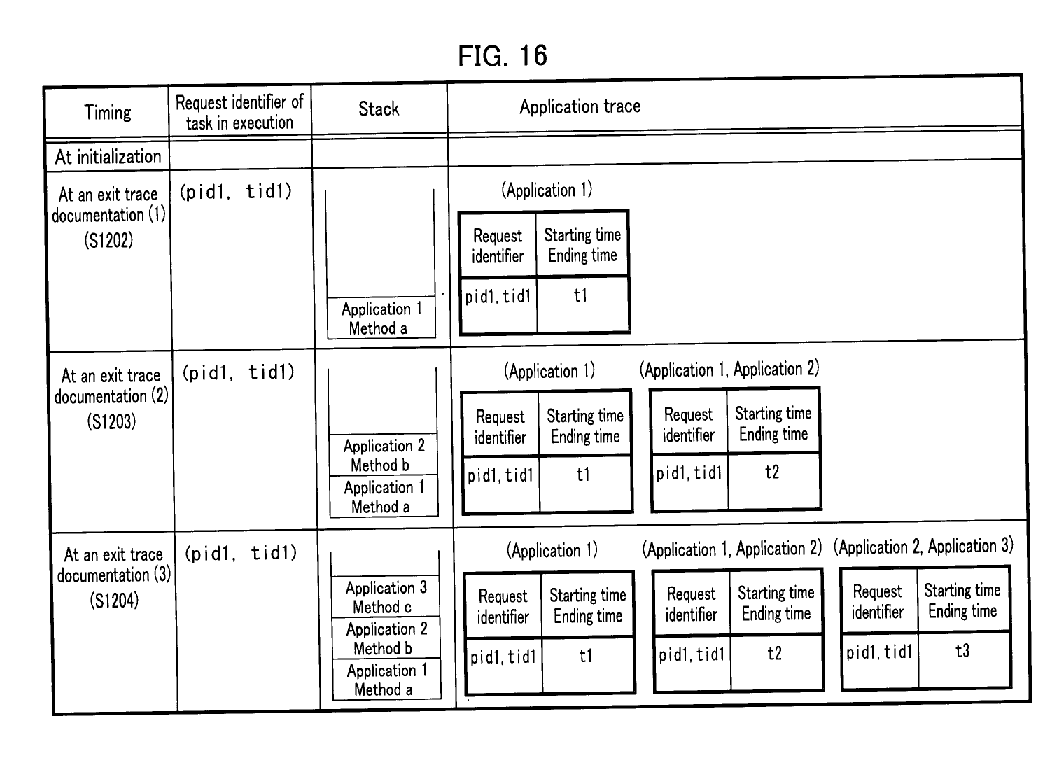

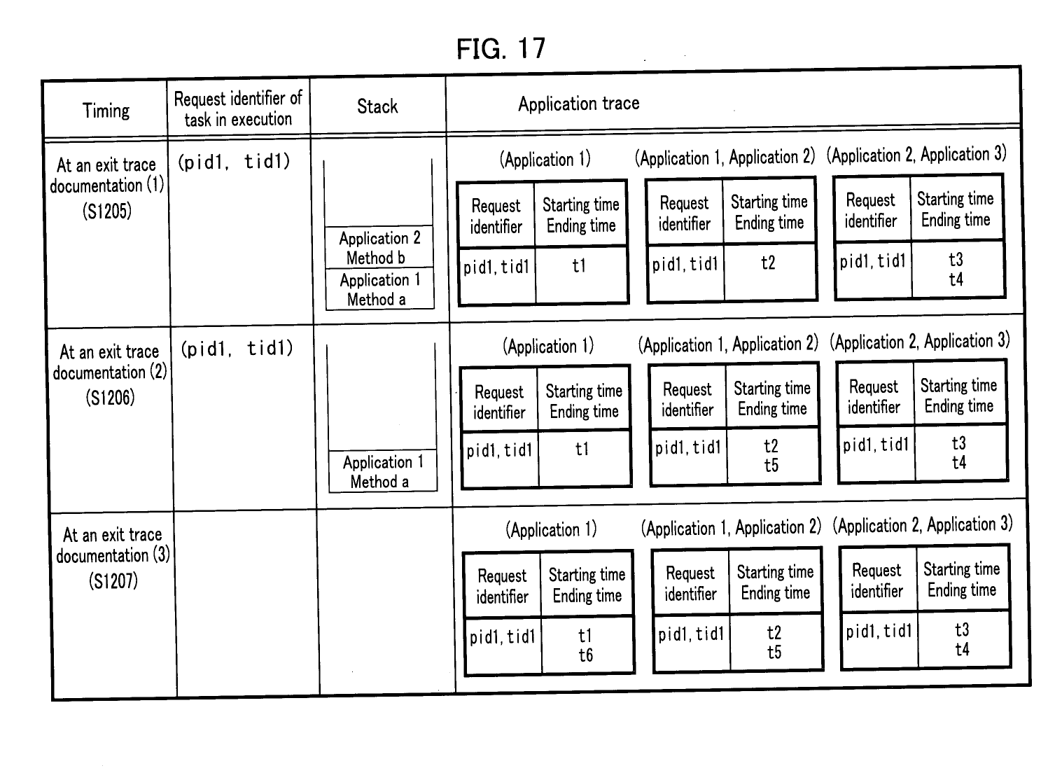

Next, a specific example of a trace document will be explained in a case where task processing is executed by executing a plurality of applications extending across a plurality of processes. FIG. 16 and FIG. 17 are illustrations showing transitions with timing of each step of a trace document in task processing of the request 1 in FIG. 12. Here, “a request identifier of a task being in execution” (refer to FIG. 2) of the task execution status managing table 311, “a stack” (refer to FIG. 4) of the request trace 331, and “an application trace” 341 (refer to FIG. 5) are shown as transitional traces.

Referring to FIG. 16, first, when the computer 100 is initialized before accepting a request from outside, a configuration of applications is documented in the task execution status managing table 311. At this time, since there is no request of a task which is in execution, the request identifier is empty.

Next, when a server program which has accepted a request calls a method a of the application 1, the entry trace is documented (S1202). At this time, a request identifier is assigned, and the request identifier (pid1, tid1) of a task being in execution is registered in the task execution status managing table 311. In the request trace 331 in which the request identifier (pid1, tid1) operates as a key, the method a of the application 1 is stacked on the stack. In the application trace 341, the request identifier (pid1, tid1) and a starting time t1 are registered in an array of which called application is the application 1.

If a method b of the application 2 is called from the method a of the application 1, the entry trace is documented (S1203). At this time, in the request trace 331, the method b of the application 2 is stacked on the stack in regard to the request identifier (pid1, tid1). In the application trace 341, the request identifier (pid1, tid1) and a starting time t2 are registered in the array of which calling application and called application are the application 1 and the application 2, respectively.

Subsequently, if a method c of the application 3 is called from the method b of the application 2, the entry trace is registered (S1204). At this time, in the request trace 331, the method c of the application 3 is stacked on the stack in regard to the request identifier (pid1, tid1). In the application trace 341, the request identifier (pid1, tid1) and the starting time t3 are registered in the array of which calling application and called application are the application 2 and the application 3, respectively.

Subsequently, referring to FIG. 17, an exit trace is documented immediately before ending processing of the method c of the application 3 (S1205). At this time, a stack of the method c of the application 3 is deleted in regard to the request identifier (pid1, tid1) of the request trace 331. In the application trace 341, an ending time t4 is documented in the array of which calling application and called application are the application 2 and the application 3, respectively, in regard to the request identifier (pid1, tid1).

Next, the exit trace is registered immediately before ending processing of the method b of the application 2 (S1206) At this time, a stack of the method b of the application 2 is deleted in regard to the request identifier (pid1, tid1) of the request trace 331. In the application trace 341, an ending time t5 is documented in the array of which calling application and called application are the application 1 and the application 2, respectively, in regard to the request identifier (pid1, tid1).

Then, the exit trace is documented immediately before ending processing of the method a of the application 1 (S1207) At this time, a stack of the method a of the application 1 is deleted in regard to the request identifier (pid1, tid1) of the request trace 331. In the application trace 341, an ending time t6 is documented in the array of which called application is the application 1 in regard to the request identifier (pid1, tid1). When the stack of the request trace 331 becomes empty, the request identifier (pid1, tid1) of the task which is in execution in the task execution status managing table 311 is deleted.

<Specific Example of Request Stopping>

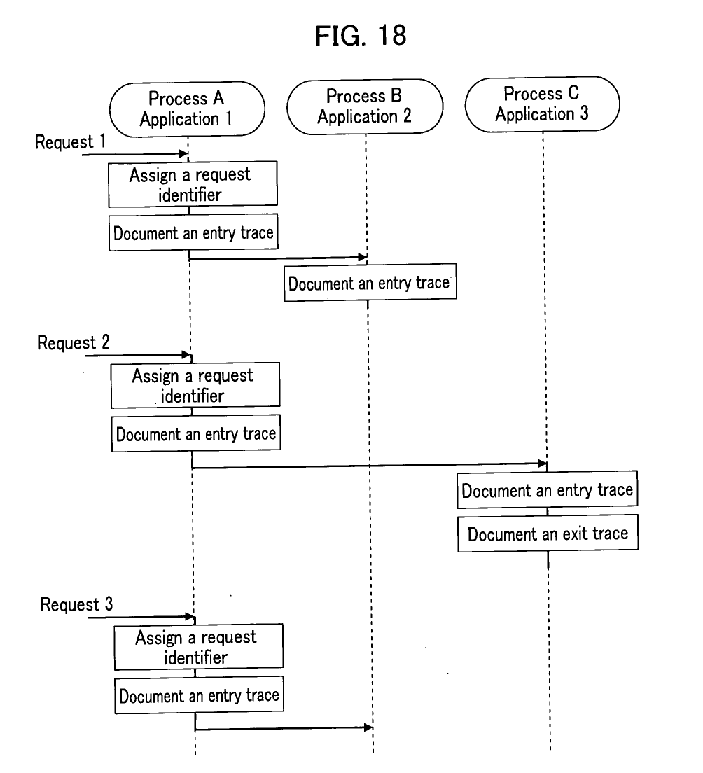

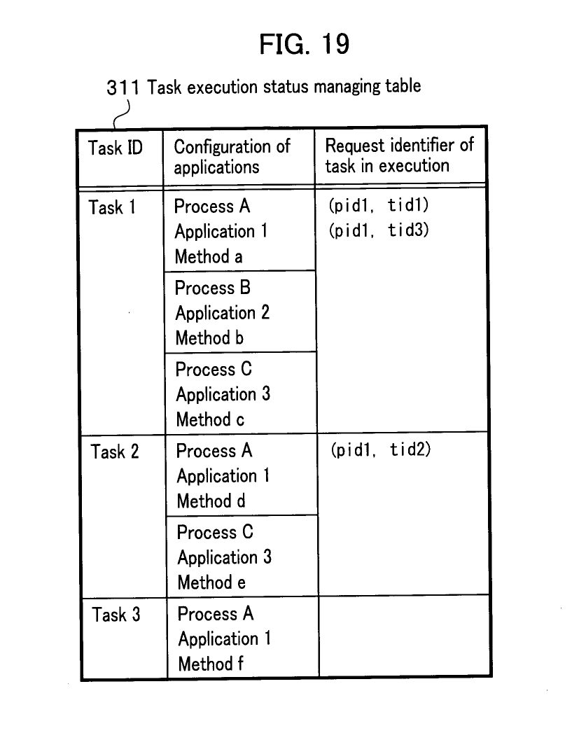

Subsequently, a specific example of processing for stopping a request will be explained. FIG. 18 is an illustration showing a status of task processing at a given moment. Here, the task ID for a request 1 and a request 3 is a task 1, and the task ID for a request 2 is a task 2. FIG. 19 to FIG. 25 show set contents of other definitions and traces at a time shown in FIG. 18. In the task execution status managing table 311 in FIG. 19, request identifiers (pid1, tid1) and (pid1, tid3)of the task 1, and a request identifier (pid1, tid2) of the task 2 are documented as the request identifiers of the tasks which are in execution.

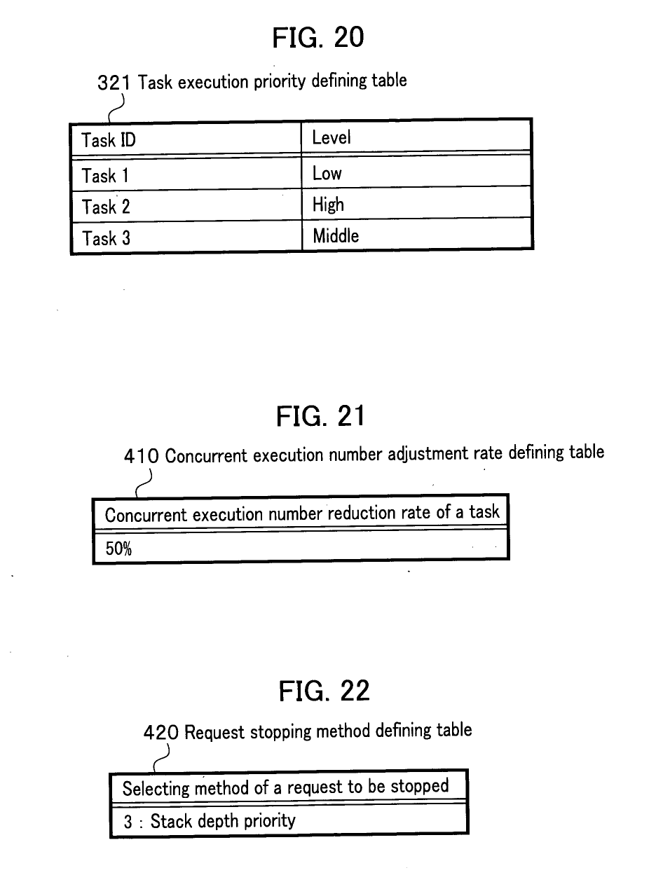

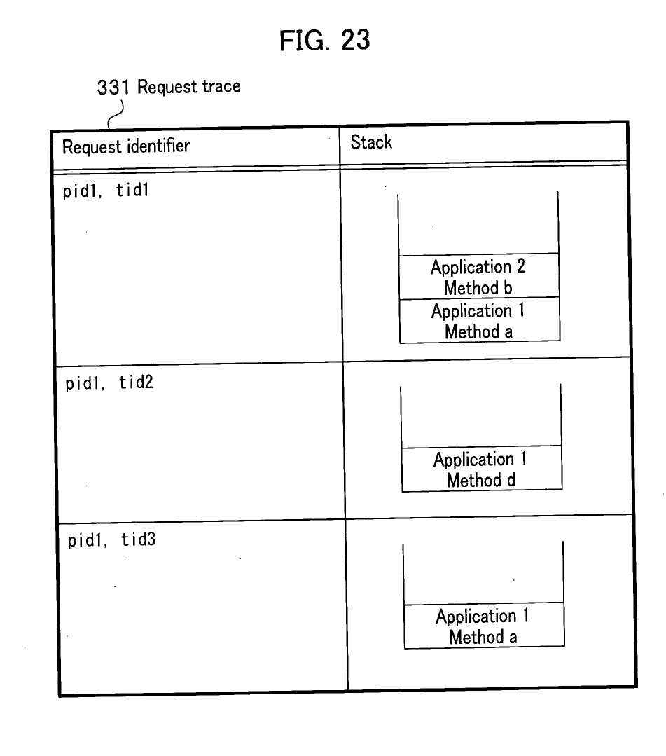

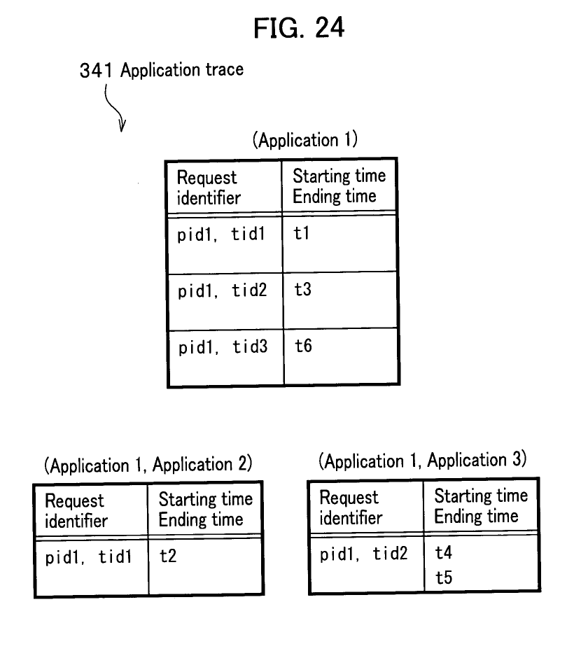

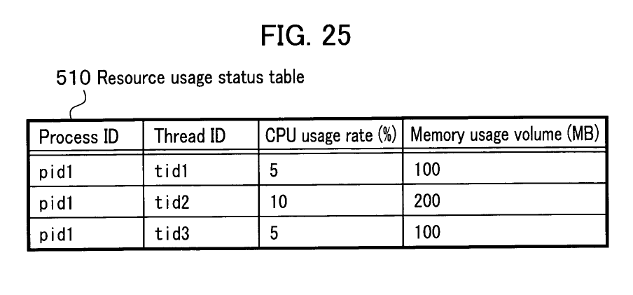

The task execution priority defining table 321 in FIG. 20, the concurrent execution number adjustment rate defining table 410 in FIG. 21, and the request stopping method defining table 420 are information defined in advance before processing the request. The request trace 331 in FIG. 23 shows a calling hierarchy of task processing for each request at the time in FIG. 18 with a stack. The application trace 341 in FIG. 24 is a document of callings among applications at the time in FIG. 18. The resource usage status table 510 in FIG. 25 indicates the CPU usage rate and memory usage volume of each thread at the time in FIG. 18. Hereinafter, a specific example of processing for stopping a request will be explained by dividing it into three, that is, stop task determining processing, stop request determining processing, and request stopping processing (refer to FIG. 18 to FIG. 25, as needed).

<Stop Task Determining Processing>

(1) Under a condition of task processing shown in FIG. 18, the resource usage (CPU usage rate or memory usage volume) of the process A reaches to a threshold, then, the resource monitoring unit 50 informs it to the task stopping unit 40.

(2) The task stopping unit 40 obtains the resource usage status table 510 (refer to FIG. 25).

(3) From the task execution status managing table 311, it can be seen that the request identifiers (pid1, tid1) and (pid1, tid3) are for the task 1, and the request identifier (pid1, tid2) is for the task 2, (refer to FIG. 19).

(4) Resource usage volumes of the task 1 and the task 2 are evaluated to be equal by checking out information obtained at (3) with the resource usage status table 510 (refer to FIG. 25).

(5) By obtaining and referring to the task execution priority defining table 321 (refer to FIG. 20), the task 1 is determined to be a stop target of the request since the execution priority of the task 1 is low.

<Stop Request Determining Processing>

(1) Referring to the task execution status managing table 311 (refer to FIG. 19), it is found that there are two requests which are in execution in regard to the task 1.

(2) Referring to the concurrent execution number adjustment rate defining table 410 (refer to FIG. 21), 50% of requests which are in execution are reduced. Then, in this example, one request is reduced.

(3) Referring to the request stopping method defining table 420 (refer to FIG. 22), since the selecting method of the stop request is “3. stack depth priority”, a request which has a deep calling hierarchy (stack) is determined to be the request of the stop target. Then, in the present example, the request identifier (pid1, tid1) is determined to be the stop target.

<Stopping Processing of Request>

(1) Block up an entry (in the example, the method a of the application 1) of the task 1. Blocking up is to prevent a new request from being accepted due to reduction of the resource usage volume during stopping of the request, although the new request is not to be accepted because the resource usage volume has been reached to the threshold.

(2) By obtaining the request trace 331 (refer to FIG. 23), a thread being in execution of (pid1, tid1) is stopped in turn (from an upper portion of the stack). That is, in the example, the thread is stopped from “the method b of the application 2” to “the method a of the application 1”.

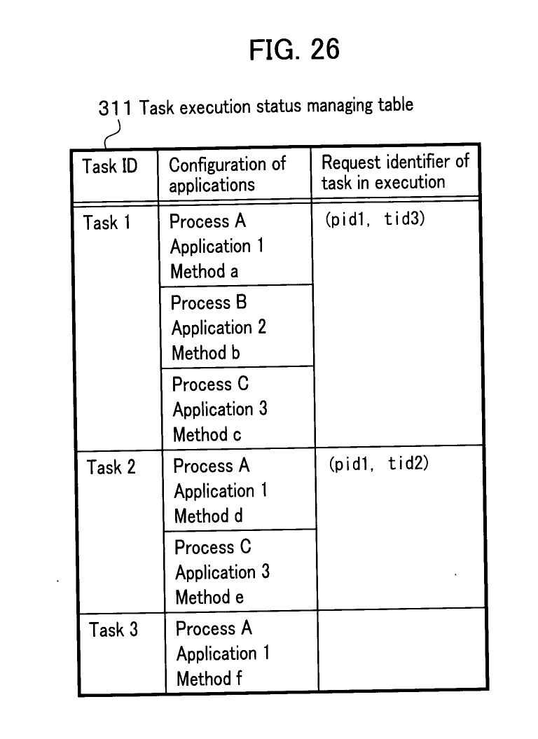

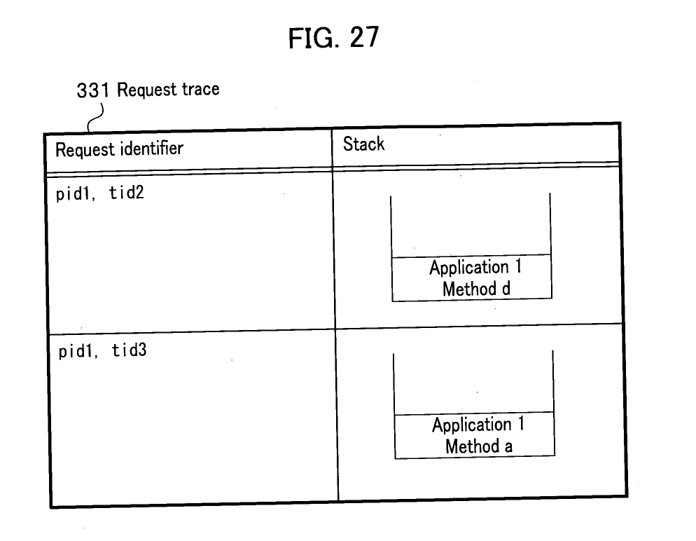

(3) Delete the request identifier (pid1, tid1) from the task execution status managing table 311 (refer to FIG. 19) and the request trace 331 (refer to FIG. 23), thereby resulting in FIG. 26 and FIG. 27, respectively.

The embodiment of the present invention has been explained. Programs (including a processing execution number managing program) to be executed by the CPU 10 of the computer 100 shown in FIG. 1 are stored in a computer readable storage medium, then, the programs are read through the medium and executed by a computer system. Accordingly, a method for managing the processing execution number and a computer according to the embodiment of the present invention are realized. Meanwhile, the programs may be provided to the computer system via a network such as the Internet

One example of preferred embodiments has been explained. However, the present invention is not limited to the embodiment. Various modifications of the present invention are possible without departing from the spirit of the present invention. For example, in the embodiment, a process extension is closed within a single computer 100. However, the process extension may be configured over a plurality of computers 100. In this case, a machine ID specific to each computer 100 is used for identifying a thread, in addition to the process ID and the thread ID. With the above, the concurrent execution number of task processing can be managed by each task unit even when a plurality of applications extending across a plurality of processes extend across a plurality of computers.

What is claimed is;:

1. A program management method for managing a number of task processing of execution when a computer for executing the task processing of a received request executes the task processing with a plurality of programs which extend across a plurality of processes,
wherein a memory unit of the computer manages a resource usage volume for each task processing; and
wherein a processing unit stops the task processing which has a largest resource usage volume when the resource usage volume exceeds a predetermined threshold.

2. A program management method for managing a number of task processing of execution when a computer for executing the task processing of a received request executes the task processing with a plurality of programs which extend across a plurality of processes,
wherein a memory unit of the computer manages:
a processing ID specific to task processing being in execution by each task;
an execution unit of the task processing being in execution of the processing ID by each processing ID; and
a resource usage volume by the execution unit of the task processing,
and wherein, when the resource usage volume exceeds a predetermined threshold, a processing unit of the computer comprises steps of:
a step of tallying up the resource usage volume of each execution unit by each processing ID which includes the execution unit;
a step of summing up a tallied up value by a task which includes the processing ID, selecting the task of which summed up value exceeds a predetermined value as the task to be stopped, and selecting the processing ID to be stopped based on a predetermined selecting condition from the processing ID of the task; and
a step of stopping the task processing of a selected processing ID.

3. The program management method according to claim 2, wherein the resource usage volume is one of memory usage volume of the memory unit and the CPU usage rate of the processing unit.

4. The program management method according to claim 2, wherein the predetermined selecting condition is that the execution unit of the task processing has a long elapsed time after starting processing.

5. The program management method according to claim 2, wherein the predetermined selecting condition is that a reception order of a request from outside is late.

6. The program management method according to claim 2, wherein the predetermined selecting condition is that a call stack among processes of task processing which is in execution is deep.

7. The program management method according to claim 2, wherein the predetermined selecting condition is that a number of the task processing to be stopped is the number which is produced by multiplying a number of task processing being in execution by a reduction rate which is set in the memory unit in advance.

8. The program management method according to claim 2, wherein, in the step of stopping the task processing of the selected processing ID, an error message is transmitted to a requester corresponding to the task to be stopped.

9. A computer for executing task processing of a received request and for managing a number of the task processing of execution when the task processing is executed with a plurality of programs which extend across a plurality of processes,
wherein a memory unit of the computer manages:
a processing ID specific to task processing being in execution by each task;
an execution unit of the task processing being in execution of the processing ID by each processing ID; and
a resource usage volume by the execution unit of the task processing,
and wherein when the resource usage volume exceeds a predetermined threshold, a processing unit of the computer executes:
tallying up of the resource usage volume of each execution unit by each processing ID which includes the execution unit;
summing up of a tallied up value by a task which includes the processing ID, selecting the task of which summed up value exceeds a predetermined value as the task to be stopped, and selecting the processing ID to be stopped based on a predetermined selecting condition from the processing ID of the task; and
stopping of the task processing of a selected processing ID.

10. A program managing program for causing a computer to implement a program management method, the program management method manages a number of task processing of execution when the computer for executing the task processing of a received request executes the task processing with a plurality of programs which extend across a plurality of processes,
wherein a memory unit of the computer manages a resource usage volume for each task processing; and
wherein a processing unit stops the task processing which has a largest resource usage volume when the resource usage volume exceeds a predetermined threshold.
